(19) United States
(12) Patent Application Publication
(10) Pub. No.: US 2024/0116099 A1
(43) Pub. Date: Apr. 11, 2024

(54) A ROBOTIC TUBE BENDING MACHINE

(71) Applicant: RAUNAQ SINGH LOOMBA, CHANDIGARH (IN)

(72) Inventor: RAUNAQ SINGH LOOMBA, CHANDIGARH (IN)

(21) Appl. No.: 18/546,284

(22) PCT Filed: Apr. 7, 2021
(86) PCT No.: PCT/IB2021/052865

§ 371 Date: Aug. 14, 2023

(30) Foreign Application Priority Data
Feb. 16, 2021 (IN) 202111006484

(51) Int. Cl. B21D 43/10; B21D 11/02; B25J 9/16

(52) U.S. Cl. CPC B21D 43/105; B21D 11/02; B25J 9/1682; B25J 9/1694; B25J 9/0096

(57) ABSTRACT

A robotic tube bending machine is disclosed. The machine includes a tube feeding tray to load tubes. The pneumatic feed separator comprising two jaws to move in a reciprocating motion to separate each tube for sequential operation. The machine includes a robotic arm assembly in communication with a controller and includes a robotic arm and a pneumatic gripper and two gripper fingers to pick each tube from the tray by simultaneous movement of multiple axis of the robotic arm to reach a three-dimensional coordinate. The collision detection module to detect presence of the robotic arm across a non-intended area by measuring force of the robotic arm and deactivate the robotic arm upon detecting a condition of collision. The machine includes a bending die to clamp each tube and a pressure die to apply pressure on the bending die to bend each tube in intricate three dimensional shapes by rotating the tubes at predefined angles by maneuvering the robotic arm.

### CROSS-REFERENCE TO RELATED APPLICATION

This application claims priority from a patent application filed in India having Patent Application No. 202111006484, filed on Feb. 16, 2021, and titled “A ROBOTIC TUBE BENDING MACHINE” and a PCT Application No. PCT/IB2021/052865 filed on Apr. 7, 2021, and titled “A ROBOTIC TUBE BENDING MACHINE.”

### FIELD OF INVENTION

Embodiments of the present disclosure relate to multifunction tube bending machine and more particularly to a robotic tube bending machine.

### BACKGROUND

In many types of applications, the formation along the same pipe of several bend which are close to each other and oriented in opposite directions is often required. Different kinds of automatic loading systems for tube bending machines are available on the market and in their simplest and cheapest form basically consist of an inclined plane on which the tube to be bent is caused to slide, the inclined plane being provided with stop members to stop the tube to be bent. The tube bending machines provided with such automatic loading systems are able to take a tube positioned on the inclined plane and to put down the worked tube on the ground by suitable control of the machine axes. However, the automatic loading systems for tube bending machines currently available work well with fixed tubes size and cross-section, but not so well with tubes of variable size.

In other cases, bends in succession are to be carried out in separate planes, for example in planes perpendicular to each other. Such bends are achieved through the sequential use of one pipe bending machine for carrying out the bending to the right for example, and a second pipe bending machine for executing the left bending. In fact, if one would try to use the same machine for carrying out a bending in the opposite way with respect to the one provided by the machine, once the first bending has been executed, the machine would be obliged to rotate the pipe. But this operation will be generally impossible when bends are very close to each other because the pipe portion that has been already bent would interfere with the bending head. It is therefore absolutely necessary to remove the pipe from the first pipe bending machine, carry it to the second pipe bending machine and make all operations necessary for placement and mounting of the pipe to the second machine. The operating steps briefly described above involve important downtime and production slowing down that give rise to an increase in the production costs when several bends in opposite ways are necessary. As a consequence, for a given outer diameter of the pipe, there is only one bending radius according to which the same pipe can be bent. Further, in case of flared tubes, the tubes comprise nuts at the end fittings which require additional placeholder on the machine for bending operation.

In some of the available bending machines, to perform the rotation of the tubes, a motor mechanism is deployed which helps robotic arms to rotate the tube gripped by the arm gripper. However, such mechanism is bulky, require lot of space which leads to difficulty in creating close bends.

Hence, there is a need for an improved tube bending machine to address the aforementioned issue(s).

### BRIEF DESCRIPTION

In accordance with an embodiment of the present disclosure, a robotic tube bending machine is disclosed. The machine includes a tube feeder unit including a tube feeding tray configured to load a plurality of tubes to be bend. The tube feeder unit also includes a pneumatic feed separator comprising at least two jaws configured to move in a reciprocating motion to separate each tube from the plurality of tubes loaded by the tube feeding tray for sequential operation. The machine includes a robotic arm assembly in communication with a controller. The robotic arm assembly includes a robotic arm and a tube gripping unit. The tube gripping unit includes a pneumatic gripper and at least two gripper fingers configured to pick up each tube from the tube feeder unit by simultaneous movement of a plurality of axis of the robotic arm to reach a three-dimensional coordinate upon receiving a signal from the controller. The tube gripping unit also includes a collision detection module configured to detect presence of the robotic arm across a non-intended area by measuring force of the robotic arm. The collision detection module is also configured to deactivate the robotic arm based on a control signal received from the controller upon detecting a condition of collision. The machine further includes a bend head coupled to the robotic arm assembly in an opposite direction. The bend head includes a bending die configured to clamp each tube from the plurality of tubes. The bend head also includes a pressure die configured to apply pressure on the bending die to bend each tube in intricate three dimensional shapes by rotating the tubes at a plurality of predefined angles by maneuvering the robotic arm upon receiving a maneuvering signal from the controller.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a schematic representation of a robotic tube bending machine in accordance with an embodiment of the present disclosure;

FIGS. 2(a) and 2(b) is a schematic representation of one embodiment of the tube feeder unit of FIG. 1 in accordance with an embodiment of the present disclosure;

FIG. 2(c) is a back view of the tube feeder unit of FIG. 1 and FIGS. 2(d) and 2(e) shows another embodiment of the tube feeder unit of FIG. 1 in accordance with an embodiment of the present disclosure;

FIG. 3(a) is a schematic of one embodiment of linear feed axis of FIG. 1, in accordance with an embodiment of the present disclosure;

FIG. 3(b) is a schematic of one embodiment of robotic gripper assembly of FIG. 1, in accordance with an embodiment of the present disclosure;

FIGS. 4(a) and 4(b) is a schematic representation of one embodiment of the bend head of FIG. 1 in accordance with an embodiment of the present disclosure; and

FIGS. 5(a) and 5(b) is a flow chart representing the steps involved in an operation of the robotic tube bending machine in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the preset disclosure relate to a robotic tube bending machine. The machine includes a tube feeder unit including a tube feeding tray configured to load a plurality of tubes to be bend. The tube feeder unit also includes a pneumatic feed separator comprising at least two jaws configured to move in a reciprocating motion to separate each tube from the plurality of tubes loaded by the tube feeding tray for sequential operation. The machine includes a robotic arm assembly in communication with a controller. The robotic arm assembly includes a robotic arm and a tube gripping unit. The tube gripping unit includes a pneumatic gripper and at least two gripper fingers configured to pick up each tube from the tube feeder unit by simultaneous movement of a plurality of axis of the robotic arm to reach a three-dimensional coordinate upon receiving a signal from the controller. The tube gripping unit also includes a collision detection module configured to detect presence of the robotic arm across a non-intended area by measuring force of the robotic arm. The collision detection module is also configured to deactivate the robotic arm based on a control signal received from the controller upon detecting a condition of collision. The machine further includes a bend head coupled to the robotic arm assembly in an opposite direction. The bend head includes a bending die configured to clamp each tube from the plurality of tubes. The bend head also includes a pressure die configured to apply pressure on the bending die to bend each tube in intricate three dimensional shapes by rotating the tubes at a plurality of predefined angles by maneuvering the robotic arm upon receiving a maneuvering signal from the controller.

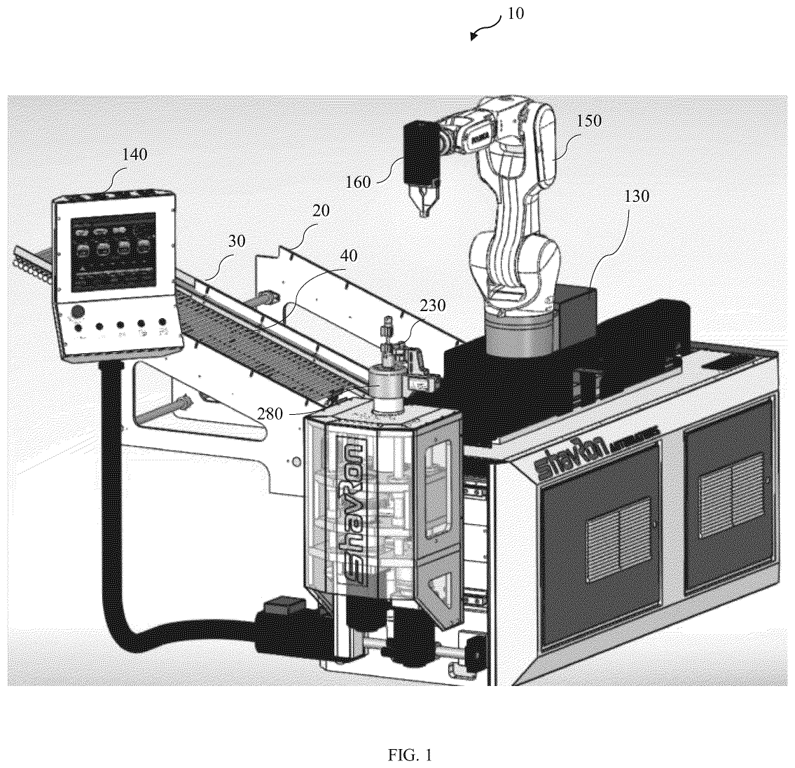

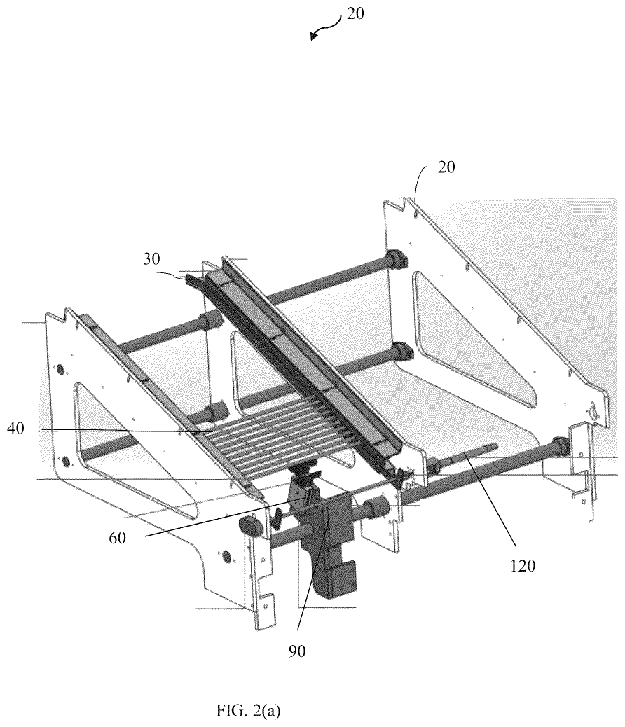

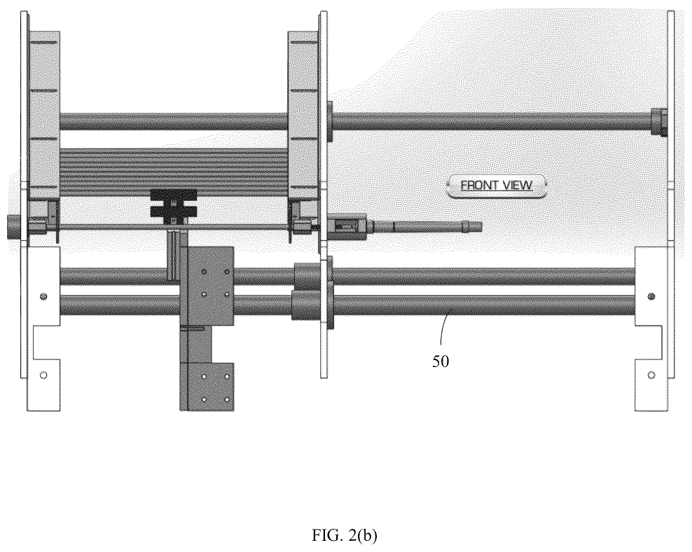

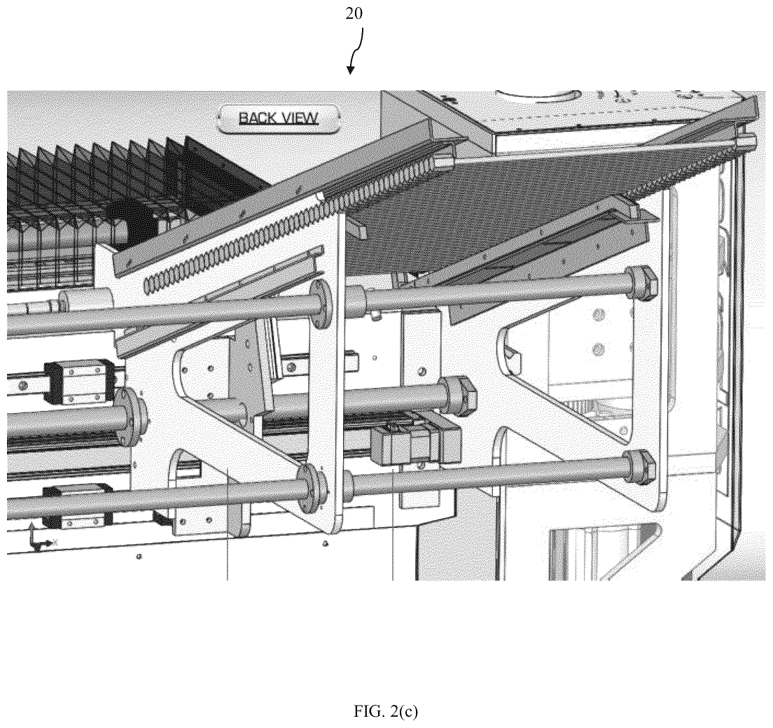

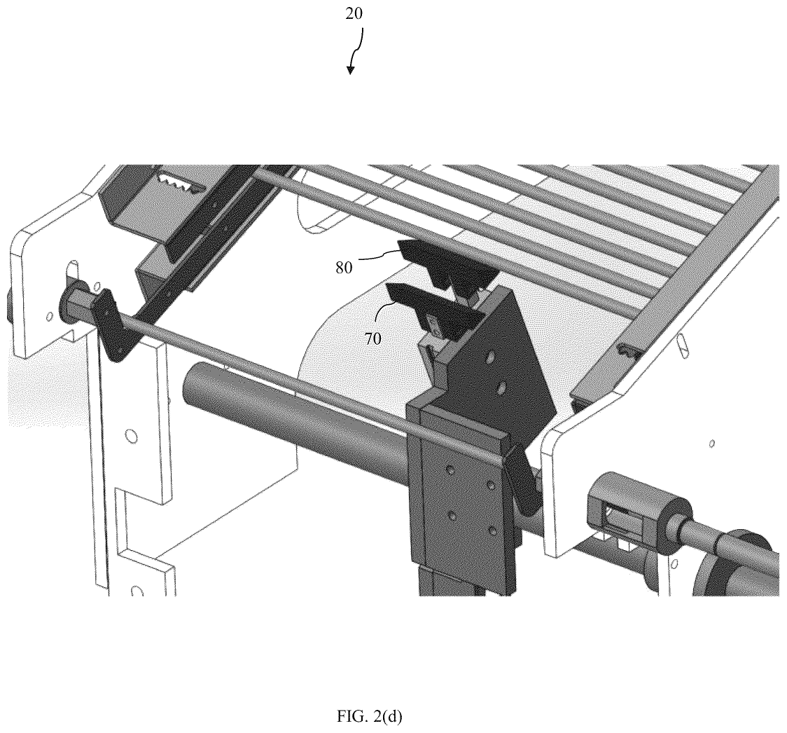

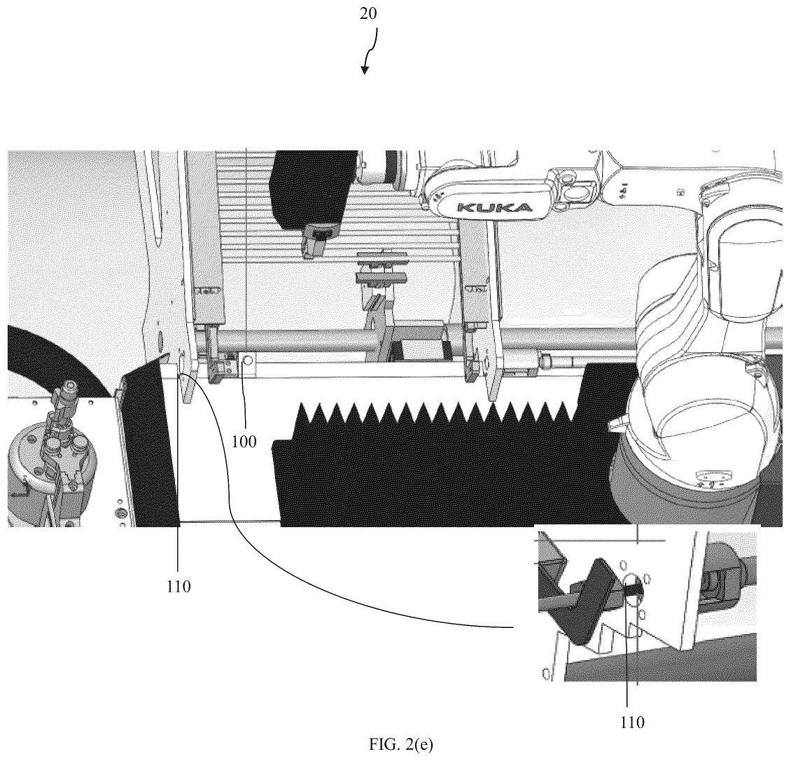

FIG. 1 is a schematic representation of a robotic tube bending machine 10 in accordance with an embodiment of the present disclosure. The robotic tube bending machine is a technology which bends straight tubes to a desired shape with the help of electromechanically interpolation axis and has a computer numerical control. The machine includes a tube feeder unit 20 including a tube feeding tray 30 which is configured to load a plurality of tubes 40 to be bend. One embodiment of the tube feeder unit is described in detail in FIGS. 2(a) and 2(b). In one embodiment, the tube feeding tray may be configured to move along a horizontal axis using a slider 50 to adjust length corresponding to each tube to be bend. Depending upon the size of each tube from the plurality of tubes, the size of the tube feeding tray may be adjusted by horizontally moving one end of the tube feeding tray into left or right direction. The tube feeding tray may move right or left using the slider which is a guide rail arrangement as shown in FIG. 2(c).

As shown in FIG. 2(d), the tube feeder unit also includes a pneumatic feed separator 60 including at least two jaws 70, 80 which are configured to move in a reciprocating motion to separate each tube from the plurality of tubes loaded by the tube feeding tray for sequential operation. In one embodiment, the at least to jaws includes a first jaw 70 which is configured to enable sliding motion for a successive tube from the plurality of tubes into an alighting area 90. In such an embodiment, the at least two jaws also include a second jaw 80 which is configured to stop a preceding tube from the plurality of tubes in the tube feeding tray by performing a reciprocating motion. The reciprocating motion is achieved by a pneumatic cylinder(s) which is a mechanical device and use the power of compressed gas to produce a force in a reciprocating linear motion.

As shown in FIG. 2(e), the alighting area 90 includes at least two proximity sensors 100, 110 which are configured to sense position of each tube in the alighting area. The at least two proximity sensors includes a first proximity sensor 100 which is configured to sense the presence of each tube in alighting area. The at least two proximity sensors includes a second proximity sensor 110 which is configured to sense alignment of each tube at a predefined position in the alighting area. In a specific embodiment, the alighting area includes a pushing rod 120 coupled on the tube feeder unit. The pushing rod is configured to align each tube at the predefined position in the alighting area by pushing each tube towards the predefined position upon detection of misalignment sensed by the second proximity sensor.

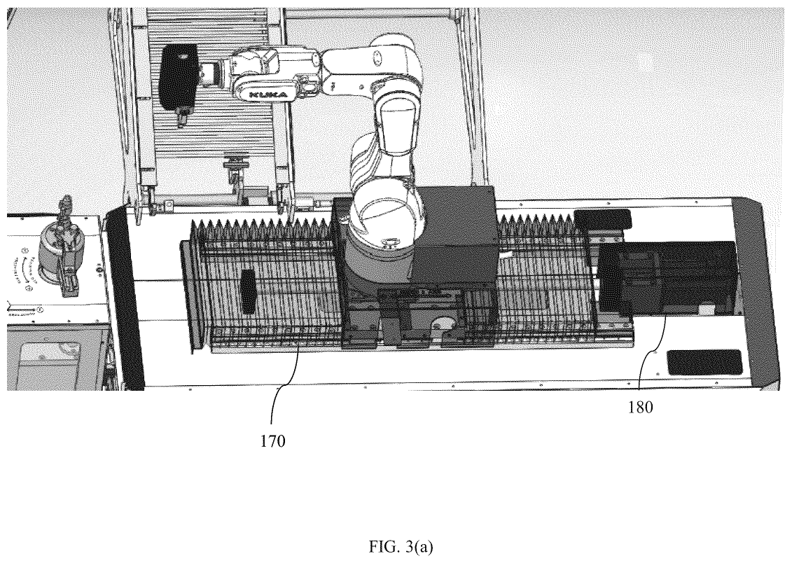

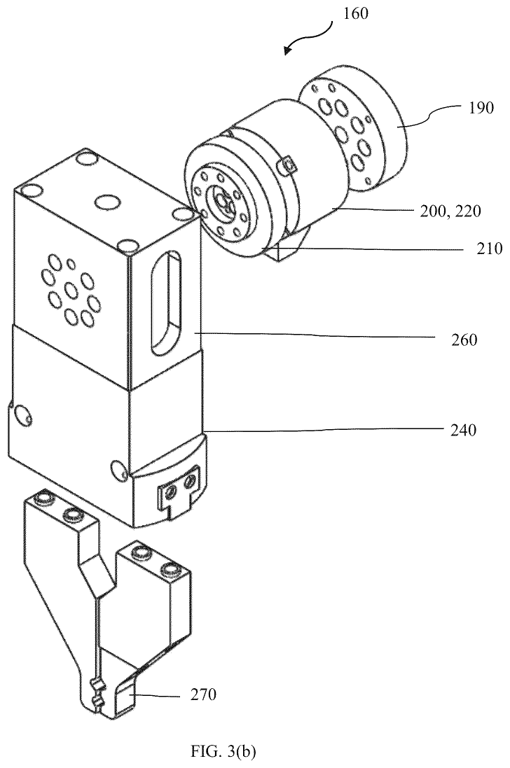

Referring to FIG. 1, the machine includes a robotic arm assembly 130 in communication with a controller 140. The robotic arm assembly includes a robotic arm 150 and a tube gripping unit 160. In one embodiment, the robotic arm assembly is coupled to a linear motion guide rails 170 via a motor 180 to perform movement along a linear feed axis as shown in FIG. 3(a). One embodiment of the robotic gripper assembly is described in detail in FIG. 3(b). In one embodiment, the tube gripping unit includes a robotic flange adapter 190 which is configured to connect the robotic arm with a collision detection module 200. The tube gripping unit includes a collision detection module including a collision detection adaptor 210 and a collision detection sensor 220 which is configured to detect presence of the robotic arm across a non-intended area by measuring force of the robotic arm. The collision detection module is also configured to deactivate the robotic arm based on a control signal received from the controller upon detecting a condition of collision.

More specifically, the collision detection module helps predict collisions between robotic arm 150 and a bend head 230 and thus prevents them from happening at all. Non-intended area for the robotic arm is determined and a virtual work envelope is created which defines the intended and non-intended area. The collision detection sensor is configured to detect the presence of a robotic arm across the non-intended area. The presence is determined by measuring the force of the robotic arm across the non-intended area. Based on the measured force, the collision detection sensor is configured to detect collision of the robotic arm and a bend head. Further, the module is configured to control and deactivate/cut off the device based on the detecting collision of the robotic arm and the bend head. Hence, avoid loss to any die and tool.

Moreover, the tube gripping unit includes a gripper mounting 260 configured to interface collision detection sensor with a pneumatic gripper 240 via the collision detection adapter 210. The pneumatic gripper is coupled to at least two gripper fingers 270. The at least two gripper fingers are configured to pick up each tube from the tube feeder unit by simultaneous movement of a plurality of axis of the robotic arm to reach a three-dimensional coordinate upon receiving a signal from the controller. The at least two gripper fingers are clamped and unclamped to pick and hold each tube to be bend. The robotic arm is a type of mechanical arm, usually programmable, with similar functions to a human arm. The arm may be the sum total of the mechanism or may be part of a more complex robot. The links of such a manipulator are connected by joints allowing either rotational motion (such as in an articulated robot) or translational (linear) displacement. The links of the manipulator can be considered to form a kinematic chain. In a specific embodiment, the at least two gripper fingers are configured to rotate each tube upon receiving a rotation signal from the controller at a predetermined angle by simultaneous movement of the plurality of axis.

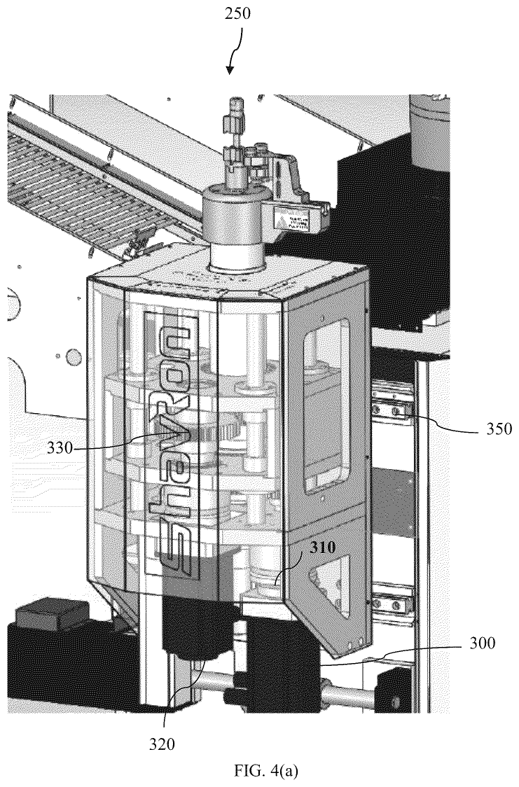

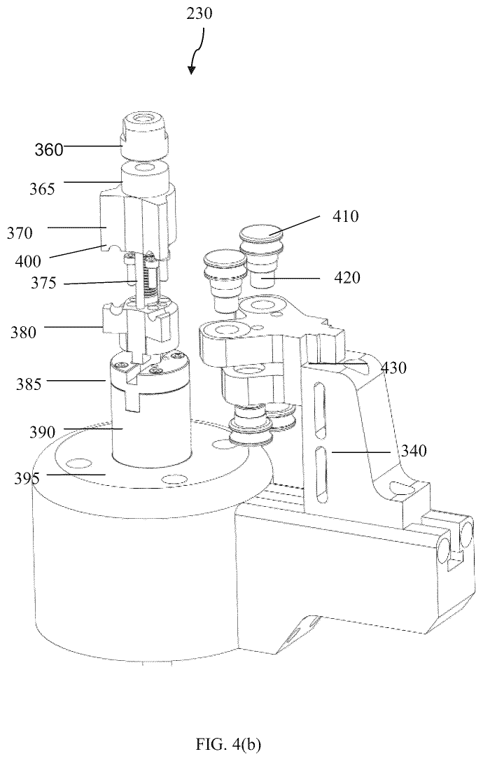

Referring back to FIG. 1, the machine further includes a bend head 230 coupled to the robotic arm assembly in an opposite direction. The bend head includes a bending die 280 configured to clamp each tube from the plurality of tubes. The bend head also includes a pressure die 290 configured to apply pressure on the bending die to bend each tube in intricate three dimensional shapes by rotating the tubes at a plurality of predefined angles by maneuvering the robotic arm upon receiving a maneuvering signal from the controller. In one embodiment, the bend head includes a first set of servo motors 300 and a first gear box 310 to rotate a main center shaft (not shown in FIG. 4(a)) of the bending die to perform the movement in first predefined coordinates. In such an embodiment, the band head also includes a second set of servo motors 320 and a second gear box 330 coupled to a pressure die tool carrier 340 perform the movement in second predefined coordinates. In a specific embodiment, the bend head also includes a pneumatic cylinder to enable up and down motion of the bending die base. In such an embodiment, the bend head includes a third servo motor, a ball screw and guide ways 350 to move the bend head in left and right direction along x-axis to help in bending operation as shown in FIG. 4(a).

One embodiment of the bend head is described in detail in FIG. 4(b). The bend head includes a bending die which further includes a plurality of parts such as a die clamping nut 360, a die holding pin 365, an upper bending die 370, at least two banding die guide pin 375, a lower bending die 380, a die holding sub base 385, a main center shaft 390 and a die holding main base 395. The upper bending die and the lower bending die are metal cavities having semicircular arcs 400 to grasp each tube from the plurality of tubes. The bend head includes the pneumatic cylinder to enable the movement of the upper bending die and the lower bending die towards each other in order to hold each tube, wherein the semicircular arcs of the upper bending die and the lower bending die are corresponding to the radius of the tube. Further, the at least two bending die guide pins are configured to enable concentric matching of the arcs of the upper bending die and the lower bending die by guiding them to overlap on each other. The upper bending die is coupled to a die holding pin and the die holding nut to hold the upper bending die a stable position. The main center shaft enables the movement of the bending die in the first predefined coordinates. Moreover, the pressure die includes pressure die runners 410, bearings 420, a pressure die tool 430 and the pressure die tool carrier 340. The pressure die includes the pressure die runner and the bearing having multiple cavities to seat with each tube during the bending operation. The pressure die tool is coupled to the pressure die runner via bearing and the pressure die tool carrier. The pressure die tool carrier may be move backward and forward via slots depending upon diameter of each tube.

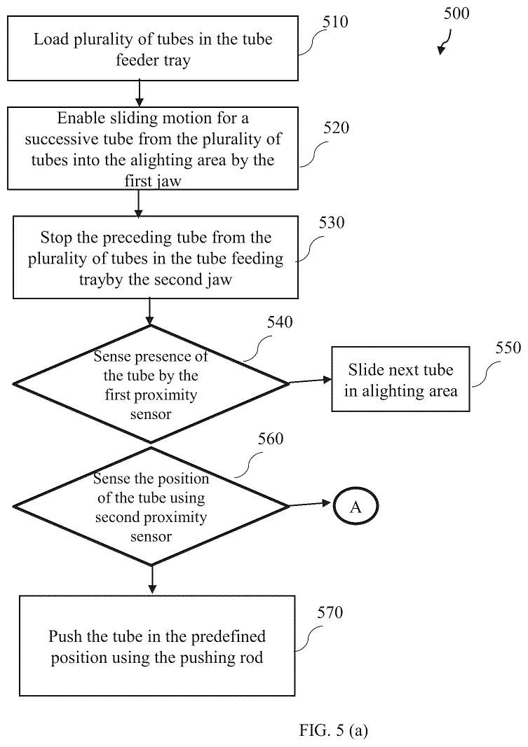

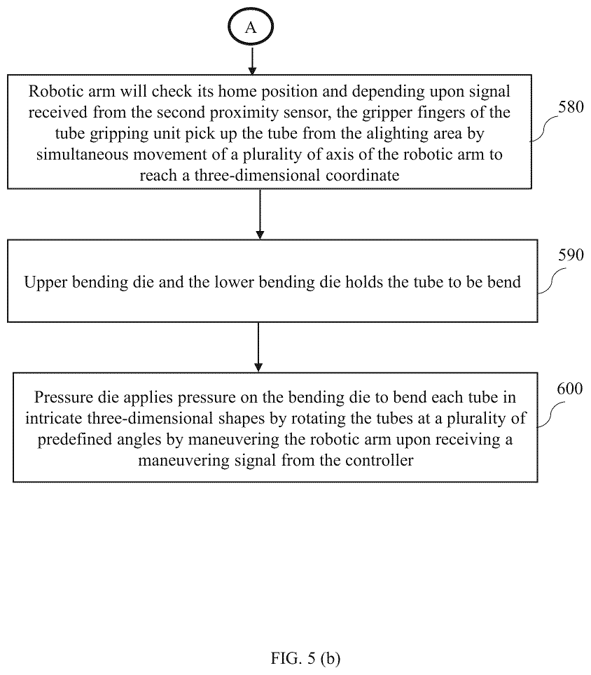

FIG. 5 is a flow chart presenting the steps involved in an operation 500 of the tube bending machine in accordance with an embodiment of the present disclosure. The plurality of tubes is loaded on the tube feeder tray in step 510. The pneumatic feed separator having the first jaw to enable sliding motion for a successive tube from the plurality of tubes into the alighting area in step 520. At the same time, the second jaw of the pneumatic fed separator stops the preceding tube from the plurality of tubes in the tube feeding tray by performing a reciprocating motion in step 530. When the tube slides in the alighting area by the first jaw, the first proximity sensor senses the presence of the tube in that area 540. If the tube is not present, it will slide the next tube in that area in step 550. Otherwise keep the other tube in holding position using the second jaw. As a next step. The second proximity sensor identify weather the placed tube is at the predefined position or not in step 560. In case if the tube is not at the predefined position, the second proximity sensor sends this data to the controller and the controller will send the sliding command to push the tube in the predefined position using the pushing rod in step 570.

When the tube is in correct position, this signal is sent to the controller and the controller will send the initialization command to the robotic arm assembly. At this point, the robotic arm will check its home position and depending upon signal received from the second proximity sensor, the gripper fingers of the tube gripping unit pick up the tube from the alighting area by simultaneous movement of a plurality of axis of the robotic arm to reach a three-dimensional coordinate upon receiving a signal from the controller in step 580. Further, the gripper fingers pick up the tube and place it on the bending die of the bend head. The upper bending die and the lower bending die holds the tube to be bend in step 590. The pressure die applies pressure on the bending die to bend each tube in intricate three dimensional shapes by rotating the tubes at a plurality of predefined angles by maneuvering the robotic arm upon receiving a maneuvering signal from the controller in step 600.

Various embodiments of the robotic tube bending machine as described above enables bending of tubes having very close bends and bending on all four quadrants around the bend head. The machine provides bending of tubes with pre-installed end fittings and bending of high pressure tubes having high wall thickness which is electrically possible by servo driven axis instead of hydraulic axis hence saving on electricity improving cycle times and accuracy of bends. Further, the machine provides automatic loading and unloading on very complex tubes with versatile maneuvering using advanced programming on an articulated robot. The machine provides bending of tubes with end fitting having minimum length of 100 mm and maximum length of 2000 mm. The machine includes collision sensor and detection system and compact work envelope. The maximum diameter achieved by the machine is up to 19 mm and maximum tube wall thickness is 3 mm.

Furthermore, this machine is fully automatic from loading of the tube to unloading, which stands out of the conventional CNC bending machine on which each straight tube needs to be loaded and unloaded manually. This machine is highly flexible in terms of bending profiles as normally CNC bending machines work on to quadrants having a left and a right and bend, but this machine works on uniquely designed electromechanical systems which can perform bending on tubes on all four quadrants. Also, this machine has a unique capability of bending the tube along end fittings.

Moreover, the most unique advantage of this machine is its capability to bend intricate 3d shapes which are impossible by any other conventional way and having automation is an added advantage. This machine can bend tubes having very close bends such as a bending length of as small as 23 mm for an 8 mm diameter tube having nuts at both ends. This machine has a uniquely designed collision detection system which can help avoiding loss of expensive equipment due to collision of robotic arm end effector to the bending head. In the event of an accident/collision within the machine, the emergency protocol will be established, and machine will come to stand still.

In addition, this machine can bend high pressure tube having very high wall thickness with the electrical servo drive which was earlier done by hydraulic system which was much slower and had its limitations. In this machine, the rotation of the tube is performed by robot itself which has an external rotary axis and may be used in various application advantages like avoidance of interfering bends. This machine has an ergonomic touchscreen display and attractive graphical user interface which makes it easier for the operator to program and run the machine.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

I claim:

1. A robotic tube bending machine comprising:
a tube feeder unit comprising:
a tube feeding tray configured to load a plurality of tubes to be bend;
a pneumatic feed separator comprising at least two jaws, configured to move in a reciprocating motion to separate each tube from the plurality of tubes loaded by the tube feeding tray for sequential operation;
a robotic arm assembly in communication with a controller, wherein the robotic arm assembly comprises:
a robotic arm;
a tube gripping unit comprising:
a pneumatic gripper and at least two gripper fingers configured to pick up each tube from the tube feeder unit by simultaneous movement of a plurality of axis of the robotic arm to reach a three-dimensional coordinate upon receiving a signal from the controller;
a collision detection module configured to:
detect presence of the robotic arm across a non-intended area by measuring force of the robotic arm;
deactivate the robotic arm based on a control signal received from the controller upon detecting a condition of collision;
a bend head coupled to the robotic arm assembly in an opposite direction, wherein the bend head comprises:
a bending die configured to clamp each tube from the plurality of tubes; and
a pressure die configured to apply pressure on the bending die to bend each tube in intricate three dimensional shapes by rotating the tubes at a plurality of predefined angles by maneuvering the robotic arm upon receiving a maneuvering signal from the controller.

2. The machine as claimed in claim 1, wherein the at least two jaws, comprises a first jaw configured to enable sliding motion for a successive tube from the plurality of tubes into an alighting area and a second jaw configured to stop a preceding tube from the plurality of tubes in the tube feeding tray by performing a reciprocating motion.

3. The machine as claimed in claim 2, wherein the alighting area comprises:
at least two proximity sensors, configured to sense position of each tube in the alighting area;
a pushing rod coupled on the tube feeder unit, wherein the pushing rod is configured to align each tube at a predefined position in the alighting area by pushing each tube upon detection of misalignment sensed by the at least two proximity sensors.

4. The machine as claimed in claim 1, wherein the tube feeding tray is configured to move along a horizontal axis using a slider to adjust length corresponding to each tube to be bend.

5. The machine as claimed in claim 1, wherein the tube gripping unit comprises a robotic flange adapter configured to connect the robotic arm with the collision detection module.

6. The machine as claimed in claim 1, wherein the at least two gripper fingers are configured to rotate each tube upon receiving a rotation signal from the controller at a predetermined angle by simultaneous movement of the plurality of axis.

7. The machine as claimed in claim 1, wherein the bending die comprises a die clamping nut, a die holding pin, an upper bending die, at least two banding die guide pin, a lower bending die, a die holding sub base, a main center shaft and a die holding main base.

8. The machine as claimed in claim 1, wherein the pressure die comprises pressure die runners, bearings, a pressure die tool and a pressure die tool carrier.

9. The machine as claimed in claim 1, wherein the bend head comprises:
a first set of servo motors and a first gear box to rotate a main center shaft of the bending die to perform the movement in first predefined coordinates;
a second set of servo motors and a second gear box coupled to a pressure die tool carrier perform the movement in second predefined coordinates; and
a third servo motor, a ball screw and guide ways to move the bend head in left and right direction along x-axis.

10. The machine as claimed in claim 1, wherein the robotic arm assembly is coupled to a linear motion guide rails via a motor to perform movement along a linear feed axis.
